(19) United States
(12) Patent Application Publication
(10) Pub. No.: US 2024/0393668 A1
(43) Pub. Date: Nov. 28, 2024

(54) PROJECTION DEVICE

(71) Applicants: K-TRONICS (SUZHOU) TECHNOLOGY CO., LTD., Suzhou, Jiangsu (CN); BOE Technology Group Co., Ltd., Beijing (CN)

(72) Inventors: Lugui Cui, Beijing (CN); Ronghui Lin, Beijing (CN); Fuchun Qi, Beijing (CN); Lixin Yang, Beijing (CN)

(73) Assignees: K-TRONICS (SUZHOU) TECHNOLOGY CO., LTD., Suzhou, Jiangsu (CN); BOE Technology Group Co., Ltd., Beijing (CN)

(21) Appl. No.: 18/697,108

(22) PCT Filed: May 10, 2023
(86) PCT No.: PCT/CN2023/093238

§ 371 Date: Mar. 29, 2024

(30) Foreign Application Priority Data
Jun. 29, 2022 (CN) 202210758847.0

(51) Int. Cl. G03B 21/20

(52) U.S. Cl. CPC G03B 21/204; G03B 21/208

(57) ABSTRACT

The present disclosure provides a projection device, which includes: a light source assembly configured to emit light; a first lens arranged at a side of a light-exiting surface of the light source assembly, quantum dots being distributed inside the first lens and excited by the light from the light source assembly to emit light; and a display screen, the light generated by the quantum dots being mixed into white light and passing through a light-exiting surface of the first lens towards a non-display side of the display screen.

### CROSS-REFERENCE TO RELATED APPLICATIONS

This application claims a priority of the Chinese Patent Application No. 202210758847.0 filed on Jun. 29, 2022, which is incorporated herein by reference in its entirety.

### TECHNICAL FIELD

The present disclosure relates to the field of display technology, in particular to a projection device.

### BACKGROUND

For a conventional projection device, a white light source is used, and a color filter is arranged in a light-exiting direction to decompose white light into red light, blue light and green light. However, due to limited spectra of the red light, blue light and green light, a resultant image has a narrow gamut, a low resolution and low color quality.

### SUMMARY

An object of the present disclosure is to provide a projection device, so as to solve the above-mentioned problems.

The present disclosure provides in some embodiments a projection device, including: a light source assembly configured to emit light; a first lens arranged at a side of a light-exiting surface of the light source assembly, quantum dots being distributed inside the first lens and excited by the light from the light source assembly to emit light; and a display screen, the light generated by the quantum dots being mixed into white light and passing through a light-exiting surface of the first lens towards a non-display side of the display screen.

In a possible embodiment of the present disclosure, the light source assembly is configured to emit light at a first wavelength, the quantum dots include a first quantum dot and a second quantum dot, the first quantum dot emits light at a second wavelength under the effect of the light at the first wavelength, the second quantum dot emits light at a third wavelength under the effect of the light at the first wavelength, the first wavelength, the second wavelength and the third wavelength are different from each other, and the light at the first wavelength, the light at the second wavelength and the light at the third wavelength are mixed into the white light.

In a possible embodiment of the present disclosure, the first lens is a Fresnel lens.

In a possible embodiment of the present disclosure, the first lens has a thickness of 1.5 mm to 2.5 mm.

In a possible embodiment of the present disclosure, the quantum dot has a particle size of 1 nm to 5 nm.

In a possible embodiment of the present disclosure, the first lens is made of polymethyl methacrylate.

In a possible embodiment of the present disclosure, the projection device further includes an optical film arranged between the first lens and the display screen, the optical film includes a polarization film and a filter film arranged one on another, and the filter film is arranged close to the first lens.

In a possible embodiment of the present disclosure, a ratio of a distance between the optical film and the display screen to a distance between the optical film and the first lens is 3 to 4.

In a possible embodiment of the present disclosure, the projection device further includes a camera lens arranged at a display side of the display screen, and a light-entering side of the camera lens is arranged close to the display side of the display screen.

In a possible embodiment of the present disclosure, the projection device further includes a second lens, and the second lens is a Fresnel lens arranged between the display screen and the camera lens.

In a possible embodiment of the present disclosure, the projection device further includes a reflector, and light exiting from the display side of the display screen is reflected by a reflecting surface of the reflector towards the light-entering side of the camera lens.

In a possible embodiment of the present disclosure, the projection device further includes a light funnel arranged between the light source assembly and the first lens.

In a possible embodiment of the present disclosure, the projection device further includes: a housing provided with an accommodation cavity in which the light source assembly, the first lens and the display screen are received; and a heat dissipation structure arranged on the housing.

### BRIEF DESCRIPTION OF THE DRAWINGS

FIG. 1 is a schematic view showing a projection device according to one embodiment of the present disclosure;

FIG. 2 is another schematic view showing the projection device according to one embodiment of the present disclosure;

FIG. 3 is yet another schematic view showing the projection device according to one embodiment of the present disclosure;

FIG. 4 is a side view of a Fresnel lens;

FIG. 5 is a schematic view showing the formation of the Fresnel lens;

FIG. 6 is another side view of the Fresnel lens;

FIG. 7 is a top view of the Fresnel lens;

FIG. 8 is an electron micrograph of a slice of the Fresnel lens with quantum dots;

FIG. 9 is a schematic view showing a quantum dot; and

FIG. 10 is another electron micrograph of the slice of the Fresnel lens with quantum dots.

### REFERENCE NUMERALS

10 light source assembly
11 light funnel
20 first lens
30 display screen
40 optical film
41 polarization film
42 filter film
50 camera lens
51 reflector
52 third lens
53 fourth lens
54 fifth lens
60 second lens
70 housing
71 heat dissipation structure

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Such words as “first” and “second” involved in the specification and the appended claims are merely used to differentiate different objects rather than to represent any specific order. It should be appreciated that, the data used in this way is replaced with each other, so as to implement the embodiments in an order other than that shown in the drawings or described in the specification. In addition, the expression “and/or” is used to represent at least one of listed objects. The symbol “/” usually refers to “or”.

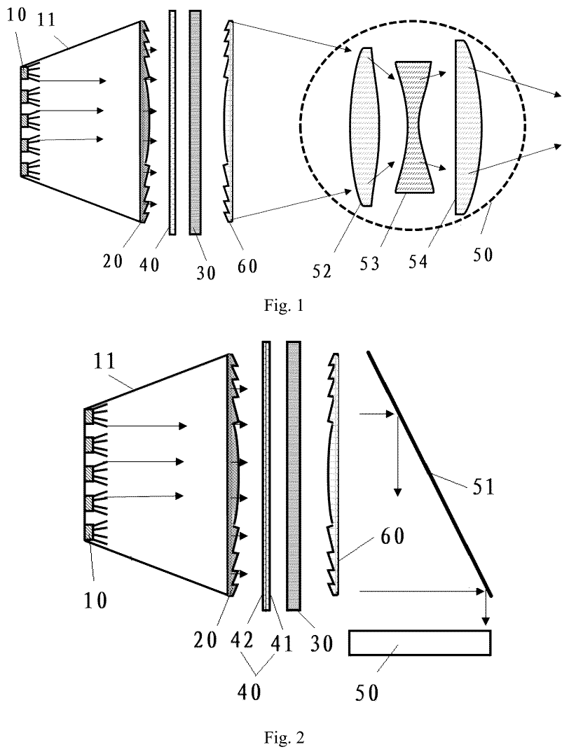

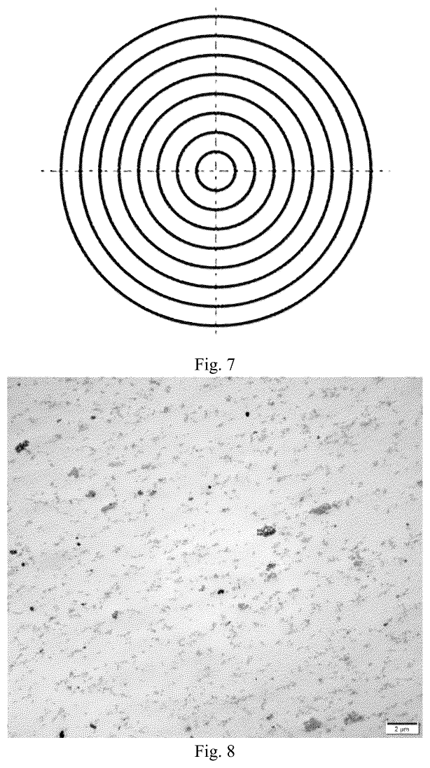

A projection device in the embodiments of the present disclosure will be described hereinafter in details in conjunction with application scenarios and FIGS. 1 to 10.

As shown in FIGS. 1 to 3, the present disclosure provides in some embodiments a projection device, which includes: a light source assembly 10, a first lens 20 and a display screen 30. The light source assembly 10 is configured to emit light, the first lens 20 is arranged at a side of a light-exiting surface of the light source assembly 10, and quantum dots are distributed inside the first lens 20 evenly. The quantum dots are excited by the light from the light source assembly 10 to emit light, and the light from the quantum dots is mixed into white light and passes a light-exiting surface of the first lens 20 towards a non-display side of the display screen 30. The display screen 30 is a Liquid Crystal Display (LCD) screen, the white light serves as a backlight source of the display screen 30, and the projection device is an LCD projector. For example, the light source assembly 10 emits blue light, and red-light quantum dots and green-light quantum dots are distributed inside the first lens 20. The red-light quantum dots are excited by the blue light from the light source assembly 10 to emit red light, the green-light quantum dots are excited by the blue light to emit green light, and the blue light, the red light and the green light are mixed into the white light. The white light passes through the light-exiting surface of the first lens 20 towards the non-display side of the display screen 30.

The first lens 20 is made of polymethyl methacrylate (PMMA). PMMA is a high molecular polymer, also known as acrylics or organic glass, and it has such advantages as high transparency, low price, being easy to be machined. PMMA is in a liquid state at a room temperature before molding, and it is easy to be bound to the quantum dots, without adversely affecting a molecular structure of the quantum dots, so it has excellent stability.

According to the embodiments of the present disclosure, the light source assembly 10 is configured to emit light towards the first lens 20, and the quantum dots are distributed inside the first lens 20. The quantum dots are not easy to fall off, and are distributed stably. The quantum dots are excited by the light from the light source assembly 10 to emit light, and the light is mixed into the white light which passes through the light-exiting surface of the first lens 20 towards the non-display side of the display screen 30 to serve as a backlight source of the display screen 30. As a result, an image formed on the display screen 30 has a wide gamut, a high resolution and high color quality.

In some embodiments of the present disclosure, the light source assembly 10 is configured to emit light at a first wavelength, and the quantum dots include a first quantum dot and a second quantum dot. The first quantum dot is excited to emit light at a second wavelength under the effect of the light at the first wavelength, the second quantum dot is excited to emit light at a third wavelength under the effect of the light at the first wavelength, the first wavelength, the second wavelength and the third wavelength are different from each other, and the light at the first wavelength, the light at the second wavelength and the light at the third wavelength are mixed into the white light. For example, the light at the first wavelength is blue light, the first quantum dot is a red-light quantum dot, and the second quantum dot is a green-light quantum dot. The first quantum dot is excited to emit red light under the effect of the blue light, the second quantum dot is excited to emit green light under the effect of the blue light, and the blue light, the red light and the green light are mixed into the white light. As compared with white light generated by fluorescent powder, the white light emitted by the quantum dots has a better color gamut range, so it is able to display an image at a high gamut.

In the embodiments of the present disclosure, the first lens 20 is a Fresnel lens, so as to converge light and improve light utilization. The first lens 20 is orange, and the light source assembly 10 includes a backlight source, e.g., an LED light source. The Fresnel lens has a unique focal point, and the light from the backlight source is converged to a small region during the design. An area of the backlight source is far smaller than that of the Fresnel lens, about 1/60 of the area of the Fresnel lens, so it is able to effectively reduce a bearing surface of the backlight source. Red-light quantum dots and green-light quantum dots are distributed in the Fresnel lens, and exited to emit red light and green light under the effect of the blue light from the light source assembly 10. The red light, the green light and the blue light are mixed to form the white light. Through the quantum dots, it is able to effectively improve a gamut range of a single LCD by at least 30%. In addition, the projection device has a high integration level, no light guide plate is provided, and the quantum dots are directly formed in the Fresnel lens, so it is able to reduce the manufacture cost.

As shown in FIGS. 4, 6 and 7, the Fresnel lens is also known as a threaded lens. The Fresnel lens is a sheet formed through injection molding, with one flat surface and another surface engraved with concentric circles. The circles are designed in accordance with light interference, diffraction, as well as requirements on relative sensitivity and acceptance angle. Its principle lies in that, the refractive energy of a lens only occurs at an optical surface (e.g., a lens surface), so an optical material is removed as possible and a curvature of the surface is maintained so as to form the Fresnel lens. FIG. 5 shows the formation of the Fresnel lens. To be specific, for an ordinary lens on the left, parts in dotted boxes that take no effect are removed to form the Fresnel lens on the right. As compared with an ordinary lens having a same focal length, the Fresnel lens is lighter and thinner. Through removing the excessive parts not affecting the diffraction, it is able to reduce the manufacture cost of the lens.

In a possible embodiment of the present disclosure, the first lens 20 has a thickness of 1.5 mm to 2.5 mm. The quantum dots have a particle size of 1 nm to 5 nm, and the quantum dots are evenly distributed in the first lens 20. The first lens 20 is made of polymethyl methacrylate. When the thickness of the first lens 20 is less than 1.5 mm, the stability of the lens is insufficient, and uncontrollable deformation easily occurs, resulting in uneven brightness. When the thickness of the first lens 20 is greater than 2.5 mm, serious chromatic dispersion occurs at an edge of an image, and color stripes such as rainbow are generated, so the imaging quality of the projection device is adversely affected. When the quantum dots are distributed in the first lens 20 having a thickness of 1.5 mm to 2.5 mm, a density of the quantum dots is not too large, and heat is distributed dispersedly, so it is able to prevent the quantum dots from being deactivated due to a too high temperature when the heat is merely retained on the surface.

In some embodiments of the present disclosure, as shown in FIGS. 1 to 3, the projection device further includes an optical film 40 arranged between the first lens 20 and the display screen 30. The optical film 40 includes a polarization film 41 and a filter film 42 arranged one on another, and the filter film 42 is arranged close to the first lens 20. Through the filter film 42, the light at an undesired wavelength is filtered out, so it is able to reduce the heat transferred to the display screen 30, thereby to protect the display screen. Through the polarization film 41, the light from the first lens 20 is polarized, so as to provide polarized light to the display screen 30.

In a possible embodiment of the present disclosure, a ratio of a distance between the optical film 40 and the display screen 30 to a distance between the optical film 40 and the first lens 20 is 3 to 4. The smaller the gap between the optical film 40 and the first lens 20, the faster the wind velocity, so it is able to improve the heat dissipation efficiency at a position corresponding to the Fresnel lens, and transfer the heat to the outside of the projection device as soon as possible, thereby to ensure the stability of the quantum dots.

In some embodiments of the present disclosure, as shown in FIGS. 1 to 3, the projection device further includes a camera lens 50 arranged at a display side of the display screen 30. A light-entering side of the camera lens 50 is arranged close to the display side of the display screen 30. Through the camera lens 50, an image on the display screen 30 is enlarged and projected onto a projection screen. The camera lens 50 includes a plurality of lenses. For example, the camera lens 50 includes a third lens 52, a fourth lens 53 and a fifth lens 54 arranged in sequence along an optical axis, and the third lens 52 is arranged close to the display screen 30. The third lens 52 is a convex lens, the fourth lens 53 is a concave lens, and the fifth lens 54 is a convex lens. The light is converged by the third lens 52 and diverged by the fourth lens 53 to eliminate chromatic aberration, and then the light is converged by the fifth lens 54. Through the cooperation of the third lens 52, the fourth lens 53 and the fifth lens 54, it is able to enlarge the image on the display screen 30 and project the enlarged image onto the projection screen.

In the embodiments of the present disclosure, as shown in FIGS. 1 to 3, the projection device further includes a second lens 60. The second lens 60 is a Fresnel lens arranged between the display screen 30 and the camera lens 50. Through the second lens 60, it is able to converge the light, improve the light utilization and shorten an optical path of a projector, thereby to improve the imaging quality and projection brightness.

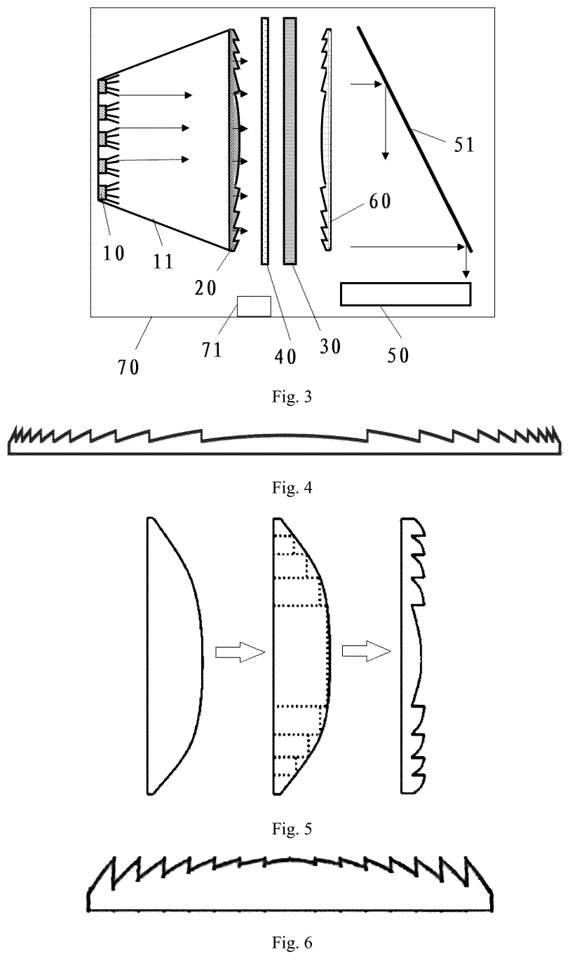

In a possible embodiment of the present disclosure, as shown in FIG. 3, the projection device further includes a reflector 51. The light from the display side of the display screen 30 is reflected by a reflecting surface of the reflector 51 toward a light-entering side of the camera lens 50. Through the reflector 51, it is able to change a direction of the light, and facilitate the cooperation between the display screen 30 and the camera lens 50, thereby to appropriately set a position relationship between the display screen 30 and the camera lens 50 in accordance with a volume and a shape of the projection device.

In a possible embodiment of the present disclosure, as shown in FIGS. 1 to 3, the projection device further includes a light funnel 11 arranged between the light source assembly 10 and the first lens 20. Through the light funnel 11, it is able to converge and guide the light, so that the light from the light source assembly 10 evenly reaches the first lens 20 to excite the quantum dots in the first lens 20 to emit light. The light funnel 11 is made of an aluminum material, and its functional surface is made of a plated aluminum layer for reflecting the light.

In a possible embodiment of the present disclosure, as shown in FIG. 3, the projection device further includes a housing 70 and a heat dissipation structure 71. The housing 70 is provided with an accommodation cavity, and the light source assembly 10, the first lens 20 and the display screen 30 are received in the accommodation cavity for protection. The heat dissipation structure 71 is arranged on the housing 70, so as to dissipate the heat and reduce a temperature in the accommodation cavity, thereby to prevent the elements from being damaged due to a high temperature, and ensure the stability of the quantum dots. The heat dissipation structure 71 includes one or more, e.g., two, fans, e.g. turbo fans. The housing 70 is provided with an air inlet and an air outlet, and the turbo fans are arranged adjacent to the air inlet and the air outlet. The turbo fan has a small air outlet to provide a high wind pressure and a high wind speed, so as to dissipate the heat to the outside of the projection device as soon as possible.

The manufacturing of the Fresnel lens with the quantum dots will be described as follows.

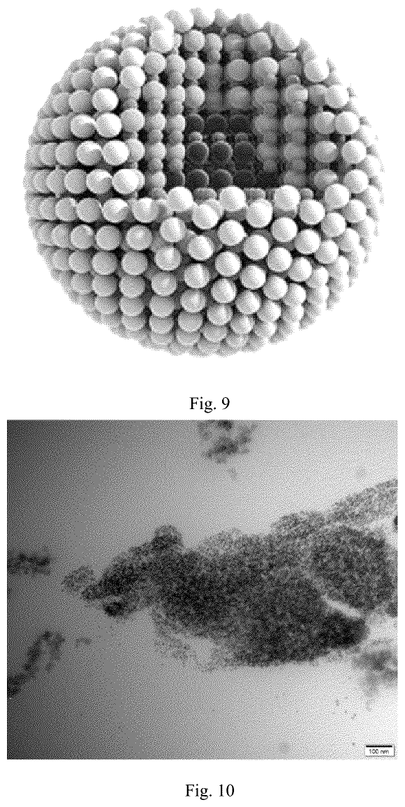

The quantum dot is a nanoparticle having a particle size of 1 nm to 5 nm. FIG. 8 is an electron micrograph of a slice of the Fresnel lens with the quantum dots after being magnified by 400 times. As shown in FIG. 8, the quantum dots are distributed evenly. PMMA in a liquid state is doped into the quantum dots at a room temperature. PMMA is dissolved in an organic solvent trichloromethane, and the structure of quantum dot is not damaged by the solvent. A ligand material for preventing electrostatic adsorption is added on an outermost layer of the quantum dot. FIG. 9 shows a microstructure of the quantum dot. The quantum dot includes a core, a shell and a ligand. The core is used for light conversion, the shell is used to protect the core, and the ligand is used to prevent the quantum dot from being adhered to the other quantum dots. During the addition, the quantum dots are dispersed through ultrasonic vibration, so as to prevent the quantum dots from being clustered. FIG. 10 shows the slice of the Fresnel lens with the quantum dots after being magnified by 7000 times. As shown in FIG. 10, there are individual quantum dots and blocks of quantum dots. In each block, there obviously exists a gap between the quantum dots, i.e., the quantum dots are not completely adhered to each other, and no clustering occurs.

In the study of color perception, CIE 1931 XYZ color space (also called CIE 1931 color space) is a color space which is first defined mathematically. A CIE1931 chromaticity diagram shows a color gamut that is perceived by human being (1931 standard observers). Color coordinates are one of the important contents of colorimetry. The measurement of the color coordinates of a light source is one of the important methods for studying the characteristics of the light source. The color coordinates are calculated in accordance with the spectral distribution of the light source as well as basic provisions, and for the commonly-used color coordinates, x represents a horizontal axis and y represents a longitudinal axis. The NTSC has formulated the standard color coordinates of red (R), green (G) and blue (B) in a CIE1931 chromaticity space coordinate system. An area (0.1582) of a triangle defined by the standard coordinates of R, G and B is used as a reference for judging a color display capability of the display device, a triangle defined by the actually-measured coordinates of R, G and B has an area S, and a ratio S/0.1582 is used as a parameter for evaluation.

During the test, a luminometer (CL200A) is used to measure the color coordinates of pure-red light, pure-green light and pure-blue light from a projector, and then a testing result in Table 1 is obtained through calculating the NTSC gamut.

TABLE 1
testing results of gamut of a conventional LCD projection
device and the projection device in the present disclosure

| | |
|---|---|
| Conventional LCD | Projection device in |
| projection device | the present disclosure |

| Name | x | y | x | y |
|---|---|---|---|---|
| R | 0.5473 | 0.3379 | 0.5915 | 0.3132 |
| G | 0.3425 | 0.5584 | 0.3152 | 0.5848 |
| B | 0.1441 | 0.1015 | 0.1486 | 0.0984 |

| | | |
|---|---|---|
| Gamut | 43.40% | 56.78% |

For the conventional LCD projection device, the light source is a white light source, and the lens is colorless and transparent, without any quantum dots. For the projection device in the embodiments of the present disclosure, the light source is a blue light source and the Fresnel lens has quantum dots. As shown in Table 1, for the projection device using the Fresnel lens with quantum dots, the gamut is increased by about 30%.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A projection device, comprising:
a light source assembly configured to emit light;
a first lens arranged at a side of a light-exiting surface of the light source assembly, quantum dots being distributed inside the first lens and excited by the light from the light source assembly to emit light; and
a display screen, the light generated by the quantum dots being mixed into white light and passing through a light-exiting surface of the first lens towards a non-display side of the display screen.

2. The projection device according to claim 1, wherein the light source assembly is configured to emit light at a first wavelength, the quantum dots comprise a first quantum dot and a second quantum dot, the first quantum dot emits light at a second wavelength under the effect of the light at the first wavelength, the second quantum dot emits light at a third wavelength under the effect of the light at the first wavelength, the first wavelength, the second wavelength and the third wavelength are different from each other, and the light at the first wavelength, the light at the second wavelength and the light at the third wavelength are mixed into the white light.

3. The projection device according to claim 1, wherein the first lens is a Fresnel lens.

4. The projection device according to claim 1, wherein the first lens has a thickness of 1.5 mm to 2.5 mm.

5. The projection device according to claim 1, wherein the quantum dot has a particle size of 1 nm to 5 nm.

6. The projection device according to claim 1, wherein the first lens is made of polymethyl methacrylate.

7. The projection device according to claim 1, further comprising an optical film arranged between the first lens and the display screen, wherein the optical film comprises a polarization film and a filter film arranged one on another, and the filter film is arranged close to the first lens.

8. The projection device according to claim 7, wherein a ratio of a distance between the optical film and the display screen to a distance between the optical film and the first lens is 3 to 4.

9. The projection device according to claim 1, further comprising a camera lens arranged at a display side of the display screen, wherein a light-entering side of the camera lens is arranged close to the display side of the display screen.

10. The projection device according to claim 9, further comprising a second lens, wherein the second lens is a Fresnel lens arranged between the display screen and the camera lens.

11. The projection device according to claim 9, further comprising a reflector, wherein light exiting from the display side of the display screen is reflected by a reflecting surface of the reflector towards the light-entering side of the camera lens.

12. The projection device according to claim 1, further comprising a light funnel arranged between the light source assembly and the first lens.

13. The projection device according to claim 1, further comprising:
a housing provided with an accommodation cavity in which the light source assembly, the first lens and the display screen are received; and
a heat dissipation structure arranged on the housing.
